(19) United States
(12) Patent Application Publication
(10) Pub. No.: US 2026/0339972 A1
(43) Pub. Date: Oct. 29, 2026

(54) AUTOMATED ITEM MATCHING

(71) Applicant: INTUIT INC., Mountain View, CA (US)

(72) Inventors: Preeti DURAIPANDIAN, Plano, TX (US); Tak Yiu Daniel LI, Frisco, TX (US); Nandish JAYARAM, Dublin, CA (US)

(21) Appl. No.: 19/188,244

(22) Filed: Apr. 24, 2025

(51) Int. Cl. G06F 16/25

(52) U.S. Cl. CPC G06F 16/25

(57) ABSTRACT

The present disclosure provides techniques for automated item matching. Embodiments include generating, based on a prioritized list specifying criteria with associated priorities, a first set of criteria for use in a first iteration of an automated item matching process between a first set of items from a first electronic data set and a second set of items from a second electronic data set. Embodiments include identifying, during the first iteration and based on the first set of criteria, a first matching between the first set of items and the second set of items. Embodiments include generating a second set of criteria for use in a second iteration of the automated item matching process according to automated criteria adjustment logic. Embodiments include identifying, during the second iteration of the automated item matching process and based on the first matching and the second set of criteria, a second matching.

### INTRODUCTION

Aspects of the present disclosure relate to automated item matching.

Data-centered analysis has gained popularity for providing the ability to model complex relationships. However, existing techniques do not efficiently or accurately recognize that items from different sources (e.g., databases, documents, or other data sources), such as stored in different data formats and/or in different manners, correspond to the same underlying entity. This problem is often particularly pronounced in data sets that include line items, which frequently include fields that are not unique.

For example, while a higher-level data set identifier may be unique across multiple electronic data sets, it is technically challenging to determine which line items within such data sets to match to one another due to the fact that fields within individual line items may not be unique with respect to one another (e.g., each line item may have a different item identifier that is specific to that type of item, and therefore may not be uniquely identifiable across different item types). Futhermore, line items may not adhere to a specific ordering that is common across data sets and may not share common item keys across data sets that would otherwise enable automated matching or sorting of such line items. Thus, it is technically difficult to determine which line items to compare to one another across data sets and, when a comparison is performed, it is technically difficult to automatically determine which line items match one another. In a particular example, it is technically challenging to automatically determine that a line item in an image of a recipt corresponds to the same underlying item or transaction as a line item in an electronic bank statement due to the differences in format and syntax, due to the lack of a common key, due to the lack of a specific ordering scheme, and/or due to the general incompatibilities between such data formats for the purposes of automated comparison techniques.

Accordingly, improved systems and methods are needed for automated item matching.

### BRIEF SUMMARY

Certain embodiments provide a method for automated item matching.

The method generally includes: generating, based on a configured prioritized list specifying matching criteria with associated priorities, a first set of criteria for use in a first iteration of an automated item matching process between a first set of items from a first electronic data set and a second set of items from a second electronic data set; identifying, during the first iteration of the automated item matching process and based on the first set of criteria, a first matching between the first set of items and the second set of items using a maximum bipartite matching; generating a second set of criteria for use in a second iteration of the automated item matching process according to automated criteria adjustment logic, wherein the second set of criteria differs from the first set of criteria in a manner specified via one or candidate modifications that are based on the configured prioritized list; and identifying, during the second iteration of the automated item matching process and based on the first matching and the second set of criteria, a second matching between a first subset of the first set of items and a second subset of the second set of items using the maximum bipartite matching.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example of electronic data sources related to automated item matching.

FIG. 2 depicts an example predictive model for automated item matching.

FIG. 3 depicts an example process for matching items.

FIG. 4 is a flow diagram of example operations for automated item matching.

FIG. 5 depicts an example application server related to embodiments of the present disclosure.

### DETAILED DESCRIPTION

Aspects of the present disclosure provide apparatuses, methods, processing systems, and computer-readable mediums for automated item matching.

Items across different data sources (e.g., websites, databases, documents, etc.) with different data storage formats, descriptions, or presentations may identify or indicate the same thing (e.g., a product or a service). For example, an item named “RFA” stored in one data format (e.g., involving encoding identifiers into an abbreviated structure) and another item named as “refrigerator A” stored in a different data format (e.g., storing a full textual identifier) may refer to the same refrigerator. In another example, two different stock keeping unit (SKU) numbers stored in different electronic data sources may point to the same product. Such items may, for example, be indicated in line items in electronic data sets.

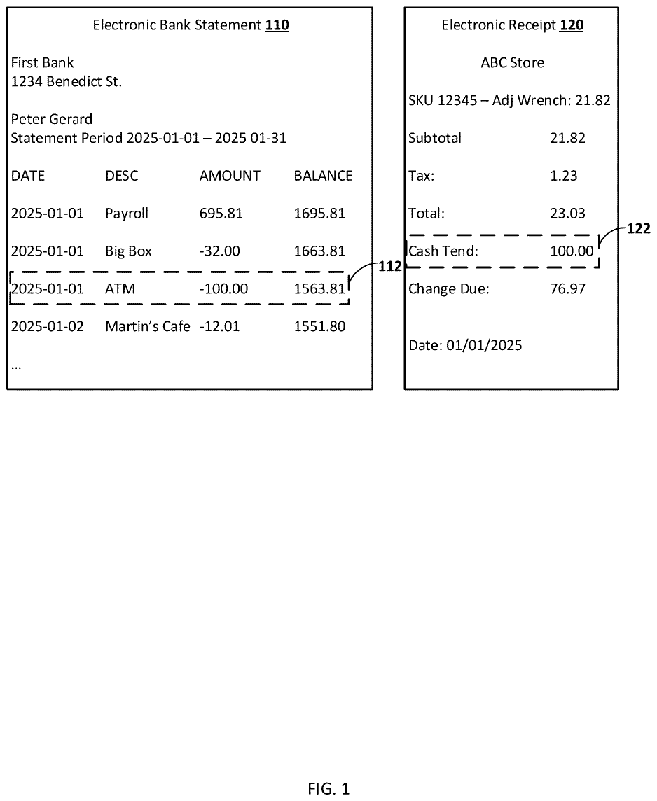

In a particular example, as described in more detail below with respect to FIG. 1 a line item in an electronic copy of a receipt may use one format and/or syntax to identify a transaction while a line item in an electronic bank statement may use a different format and/or syntax to identify the same transaction.

Existing automated techniques have difficulties in correctly identifying items from different data sources (e.g., different types of electronic documents, databases, websites, or the like) having different data formats or identifying information (e.g., attribute values) but actually corresponding to the same product or service, resulting in inaccuracies and inefficiencies in automated data analysis tasks. For example, automated techniques that involve searching for direct string matches between items from two different electronic data sources may result in such inaccuracies and inefficiencies in cases where different data storage formats or identifiers are used. Furthermore, there is no existing technique for determining which items to compare to one another (e.g., if the items are included as line items in data sets, such as electronic receipts or electronic bank statements, that may include non-unique fields. There is often ambiguity when multiple valid matches are detected using existing techniques, and the irrelevance of ordering in many line items data sets (e.g., receipts, bank statements, or the like) may make automated comparison technically challenging, and a local optimum matching determined using prior techniques may not accurately reflect the matching performance.

One existing technique for automated comparison of different data sets is DeepDiff, which recursively searches for differences of dictionaries, iterables, strings, and other objects. DeepDiff allows for comparisons across out of order objects. However, DeepDiff struggles to identify correct line items to compare to one another in data sets that include such line items, resulting in low accuracies and inefficiencies. Even when guided by custom comparison instructions (e.g., that accept a function pointer to compare), DeepDiff generally is unable to handle the case where more than one line item meets a matching criteria for being a match of a particular line item. For instance DeepDiff does not have a mechanism for determining which line items are best matched to one another across different line item data sets with non-unique fields.

Techniques described herein address these challenges through an iterative matching process for item matching, involving the use of automated matching criteria adjustment logic by which matching criteria are varied across different iterations. For example, the automated matching criteria adjustment logic may be based on a configured prioritized list (e.g., configured by a user) that specifies priorities of each of a plurality of matching criteria that may be used in automated item matching. The matching criteria may be automatically adjusted on each iteration of an automated matching technique, such as a maximum bipartite matching algorithm, while excluding any weak matches from the previous iteration, thereby converging on a global optimal match. Thus, while existing techniques such as DeepDiff are not equipped to resolve cases where multiple potential matches are identified in one data set for a given line item in another data set, techniques described herein are configured to iteratively hone in on the global optimum match for each line item through an automated process that progressively reduces the problem space and dynamically explores different matching criteria.

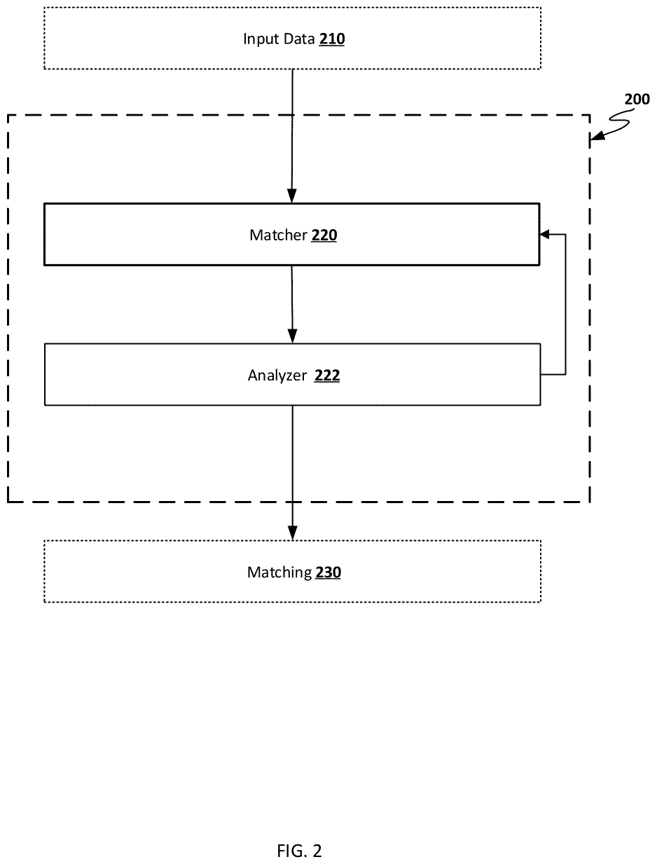

For instance, ttems from two different electronic data sets, such as an electronic receipt and an electronic bank statement, may indicate multiple attributes, such as descriptions, item codes, prices, titles, and so on, in one or more different data storage formats. A difference between each item in one electronic data set and each item in the other electronic data set can be computed based on a set of criteria associated with the attributes. The set of criteria may be generated based on the configured prioritized list of criteria (e.g., configured by a user), such as selecting at least a subset of the criteria in the prioritized list in order of priority based on a configured criteria size (e.g., specifying how many criteria should be used in any given matching iteration). For example, a criterion (e.g., selected from the configured prioritized list) can indicate an attribute and a distance metric and/or a weight associated with the attribute, such that a distance may be computed for the attribute. The set of criteria may indicate all attributes or a configured set of attributes. The difference may be derived from the distances for attributes included in the set of criteria. Details regarding computing the difference based on the attributes can be seen below with respect to FIG. 2

Based on the differences, a maximum matching can be found (e.g., via maximum bipartite matching) between the two sets of items. If the two sets have the same size, a maximum matching occurs when every item in one set has a matching item in the other set. Alternatively, if the two sets have different sizes, a maximum matching occurs when every item in the smaller set has a matching item in the larger set, but an item in the larger set may remain unmatched.

However, not all matches in the maximum matching are accurate, due to discrepancies or poor data quality (e.g., missing data) associated with some attributes. For example, there may not be a match between items indicating the same product or service due to differing data storage formats and/or other electronic data discrepancies. In another example, items in a match may have some common values (e.g., sharing a same price) but may not actually correspond to the same product or service.

Accordingly, a weak match between two items can be excluded from the maximum matching (e.g., based on the determined difference between the items meeting a threshold), such that unmatched items after the exclusion are excluded from the maximum matching.

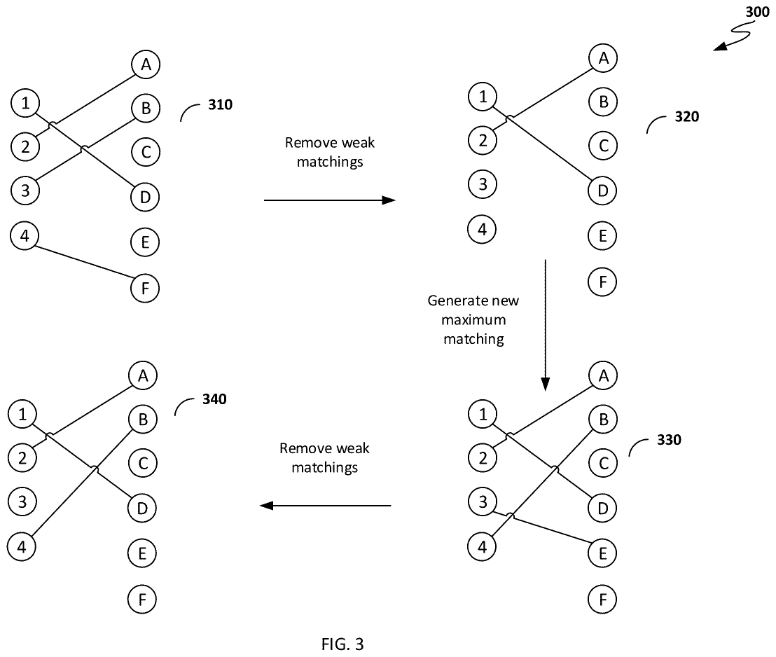

The unmatched items from the two sets can then be matched in a new iteration of the process. A new set of criteria (e.g., indicating a new set of attributes, a modified distance metric for an attribute, a modified weight for an attribute, and/or the like) may be created for the unmatched items, so as to avoid the discrepancies or poor data quality associated with some attributes. The new set of criteria may be automatically generated based on the configured prioritized list of criteria, such as performing one or more automated adjustments to the set of criteria according to automated criteria adjustment logic (e.g., that is based on the configured prioritized list). Therefore, new differences may be calculated for the unmatched items using the new set of criteria, and a new maximum matching may be generated for the unmatched items. Details regarding generating a matching for unmatched items can be seen below with respect to FIGS. 2-3

The automated process may terminate when an exit condition is met, such as when no match is excluded from a maximum matching, when no new set of criteria can be generated, and/or the like.

By utilizing a particular dynamic and iterative process, techniques described herein overcome deficiencies in existing techniques for automated item matching. For example, while existing techniques rely heavily on a single-pass approach, techniques described herein allow for robust identification by iteratively excluding weak matches and then generating new matching for unmatched items according to dynamically adjusted criteria on each successive iteration. For example, using a newly created set of criteria in generating each new maximum matching helps to reduce sources of error in the automated analysis. Additionally, dynamically determining iterative modifications to the set of attributes used and parameters associated with attributes in the set of criteria, through automated criteria adjustment logic based on a prioritized Isit of matching criteria, provides flexibility and enhances explainability of the result of the automated process. Enabling user configuration of the prioritized list of criteria that is used in generating and/or automatically adjusting a set of criteria applied in each matching iteration allows for precise, dynamic, and accurate automated matching.

Thus, embodiments of the present disclosure provide a technical improvement with respect to conventional techniques for automated item matching, achieving greater accuracy than such conventional techniques while executing in a resource-efficient manner through a focused and dynamic approach in which exit conditions are regularly evaluated. By executing in an iterative and dynamic manner according to flexible automated logic, techniques described herein are enabled to successfully identify matches across disparate electronic data sources, even when differing data storage formats are used, in a way that is not possible with prior automated matching techniques. For example, aspects of the present disclosure enable efficient and accurate automated matching of line items across different electronic data sets in a manner that is not possible with prior automated matching techniques. Where existing techniques such as DeepDiff fail to disambiguate between multiple potential matches for a given line item, aspects of the present disclosure efficiently and accurately converge on a global optimum match through an iterative, dynamic, and focused automated matching approach that is driven by automated criteria adjustment logic and a successively shrinking problem space.

For example, experimental results indicate that techniques described herein result in high levels of automated matching accuracy that progressively improve between each iteration, such as an accuracy of 80% on a first iteration increasing to an accuracy of 87% on a second iteration after automatically adjusting the matching criteria through automated criteria adjustment logic. Experimental results indicate that techniques described herein produce high levels of precision, recall, accuracy, and coverage. Aspects of the present disclosure are scalable (e.g., due to resource efficiency of techniques described herein) and can be used to evaluate any types of line items, with only the matching criteria being provided as inputs.

### Example Electronic Data Sources for Automated Item Matching

FIG. 1 depicts an example of electronic data sources for automated item matching. In particular, FIG. 1 depicts an electronic bank statement 110 (e.g., which may be an image, a scanned document, a computer-created document, and/or the like) and an electronic receipt 120 (e.g., which may be an image, a scanned document, a computer-created document, and/or the like).

As shown, eletronic bank statement 110 and electronic recipt 120 each include multiple line items. Existing automated item matching techniques would be unable to determine which line item in electronic recipt 120 to compare to a particular line item in eletronic bank statement 110 due to the differences in format, identifiers, data types and/or the like, and due to the general incompatibility of the two documents for automated item matching purposes.

For example, DeepDiff and other similar algorithms may compare each line item across the two documents to determine the diffences and similarities, but would be unable to accurately identify a match. Line item 112, for instance, in electronic bank statement 110 may be a true match for line item 122 in electronic receipt 120, such as because line item 112 identifies an ATM withdrawal of one hundred dollars that was used to pay for the purchase at A B C store on Jan. 1, 2025, for which line item 122 of receipt 120 indicates one hundred dollars cash was provided. However, beyond the monetary amount there are no other similarities between the two line items in these different documents. There is no common key or identifier that would otherwise link these line items. The other text associated with these line items does not match, and differences identified by a technique such as DeepDifff would be greater than the similarities.

Techniques described herein, however, enable a match between line item 112 and line item 122 to be accurately identified in an automated manner. For example, by iteratively performing an automated item matching process (e.g., involving maximum bipartite matching) while varying the match criteria on each iteration according to automated criteria adjustment logic, aspects of the present disclosure enable different match criteria to be iteratively explored while progressively reducing the problem space (e.g., by excluding and reevaluating any weak matches after each iteration). Thus, once the optimal set of match criteria are identified for a given pair of line items, such as line items 110 and 120, which in this case may include a matching monetary value, a semantic relationship between embeddings of “ATM” and “cash tend” indicating these strings being within a threshold amount of similarity of one another (e.g., which may be a particular distance metric), a matching date, particular weights associated with these attributes, and/or the like, a global optimum match for line item 112 may be determined to be line item 122. Such techniques are described in more detail below.

### Example Predictive Model for Automated Item Matching

FIG. 2 depicts an example predictive model 200 for automated item matching. Predictive model 200 can receive input data 110 and generate matching 330 as the output. Predictive model 200 can be deployed either online (e.g., for batching processing or real-time processing) or offline.

Input data 110 and matching 330 may be represented via appropriate data structures, such as matrices, tables (e.g., Pandas DataFrames), dictionaries, lists, JavaScript Object Notation (JSON) objects, graphs (e.g., nodes in graphs), texts, and/or the like.

Input data 110 can indicate two sets of items (e.g., related to products, services, and/or the like). The two sets of items can have the same size or different sizes. For simplicity, the following discussion assumes that the size of a first set is no larger than (e.g., smaller than or equal to) the size of a second set. In other words, when the two sets have different sizes, the first set represents the smaller set whereas the second set represents the larger set.

Items (e.g., included in or represented as line items) in the first set or the second set may indicate a plurality of attributes (e.g., descriptions, item codes, prices, titles, and/or the like) that is common across the two sets. In some aspects, the first set and the second set differ in data storage format, such including comparable types of information stored in differing formats. Thus, prior automated matching techniques may be unable to correctly compare the otherwise comparable types of information due to such format differences and/or due to the inclusion of non-unique fields that make automated comparison across the data sets technically challenging.

The two sets of items indicated in input data 110 can be provided to matcher 220 to generate a maximum matching between the two sets of items.

Matcher 220 can generate first a set of criteria related to the plurality of attributes. Each criterion may indicate an attribute as well as a distance metric associated with the attribute or a weight associated with the attribute.

In some examples, the set of criteria indicates all attributes and the associated distance metrics or weights.

In some examples, alternatively, the set of criteria has a configured size. In an example, the attributes include “description,” “item_code,” “price,” “title,” “timestamp” and so on. In this example, the set of criteria has a size of 2 (e.g., indicating only 2 attributes) and include the attributes “item_code” and “price” as well as the associated distance metrics or weights. The configured size of the set of criteria can reduce computational costs and increase efficiency of the process to match items.

The distance metric can be based on the data structure of the attribute values for an attribute. In an example, the attribute “description” is represented using strings. Accordingly, the distance metric associated with the attribute “description” may be the edit distance (also known as the Levenshtein distance). In some examples, alternatively, the distance metric includes one or more of a Manhattan distance (also known as L-1 distance), a Euclidean distance (also known as L-2 distance), a cross entropy loss, and/or the like.

In some examples, additionally, the distance metric indicates whether or not fuzzy matching is used (e.g., via a binary indication, a flag, and/or the like).

The weight associated with the attribute may be configured or learned via a machine learning model, such as a regression model (e.g., linear regression), a gradient boosted tree, a neural network, and/or the like. For example, a machine learning model can be trained based on a training data set comprising attributes of pairs of items confirmed to be matches, and the machine learning model may learn, through the training process, which weights for particular attributes produce the most accurate matching predictions based on comparing predicted matches between items (e.g., predicted matches output by the machine learning model based on attributes of the items) to labels indicating whether the items are confirmed to be matches. Details regarding the weight can be seen in the discussion below.

Matcher 220 can compute a distance for each attribute between two items from the two sets, respectively, based on the set of criteria. For example, item A may have the string “fridge” for attribute “description” whereas item B may have the string “refrigerator” for attribute “description.” In this example, the distance between item A and item B for attribute “description” may be the edit distance between their attribute values, which is 8.

In some examples, a distance is computed based on a fuzzy matching between attribute values for an attribute. The fuzzy matching may be specified (e.g., configured in the distance metric) for certain attributes in the set of criteria, as discussed above. For example, an item having the string “regular cr #01” for its “description” while another item having the string “regular cr #01\nself@3.199/g” for its “description” may have a distance=0 for “description” because a fuzzy matching exists for the two strings.

In some examples, attribute values are converted into vectors (e.g., using embedding tools, such as a Bidirectional Encoder Representations from Transformers (BERT), word2vec, or a transformer). In such examples, the distance for the attribute between two items is computed based on the vectors associated with the two items.

Matcher 220 can then compute a difference between each item in the first set and each item in the second set based on the distances. The difference may be aggregated (e.g., as a sum) or averaged from the distances. In some examples, the difference is computed based on the weights specified in the set of criteria (e.g., as a weighted sum or a weighted average).

Matcher 220 can then formulate a problem based on the differences. The solution to the problem is a maximum bipartite matching between the two sets of items. For example, the problem may be an optimization problem, such as an assignment problem, a max flow problem, a min cost flow problem, a linear programing, and/or the like. Accordingly, the solution may be via appropriate solvers or algorithms adapted to solve the formulated problem, such as Jonker-Volgenant algorithm, alpha-beta pruning search, Hungarian algorithm, stable marriage algorithm, Blossom algorithm, Hopcroft-Karp algorithm, a cycle canceling algorithm, a successive shortest path algorithm, an out-of-kilter algorithm, network simplex method, push-relabel algorithm, or a linear programing.

The maximum matching can be provided to analyzer 222 to assess the quality of matching. If the quality is deemed satisfactory (e.g., when exit conditions are met), analyzer 222 can output the maximum matching as matching 330. Otherwise, analyzer 222 can further process the maximum matching (e.g., by removing weak matches from the maximum matching) and provide the unmatched items in the first set and second set to matcher 220 for further matching.

Analyzer 222 can identify weak matches in the maximum matching that have differences between the matched items meeting a threshold, and then exclude (e.g., remove) those weak matches in the maximum matching, such that the items indicated in the weak matches becomes unmatched.

For example, an item may be matched to another item when both items do not identify or indicate the same thing (e.g., the same product or service), especially when there are discrepancies in attribute values or poor data quality (e.g., missing data) in some of the attributes.

In addition, not all items in a smaller set (e.g., the first set) would have a matching item in a larger set (e.g., the second set). For example, an item in a receipt (e.g., a product or a service) may not appear in a credit card statement because the user may have paid for the item using another credit card (e.g., via split payment). However, in the maximum matching between items in the receipt and items in the credit card statement, the item may nevertheless have a matching item in the credit card.

A weak match can be excluded from the maximum matching, for example, when the difference computed based on the set of criteria between the matched items meets a threshold. The threshold can be static (e.g., having a fixed value, such as 5) or dynamic (e.g., based the values indicated in the set of criteria).

Items excluded from the maximum matching would become unmatched. For example, the unmatched items may include a subset of the first set of items and a subset of the second set of items. In other words, if an item is unmatched after the exclusion, the item is excluded from the maximum matching.

If the subset of the first set (e.g., the smaller set) is null (e.g., has no item), all items in the first set has a matching that is sufficiently satisfactory (e.g., with a difference not meeting the threshold), and analyzer 222 can output the maximum matching between the two sets of items.

However, when the subset of the first set includes one or more items (e.g., when an item in the first set is excluded from the maximum matching), there is a need to find maximum matches for the unmatched items to correctly pair some unmatched items.

The set of criteria may not be suitable for matching the unmatched items, due to discrepancies or poor data quality associated with at least some attribute in the set of criteria.

Accordingly, analyzer 222 can generate a new set of criteria. Analyzer 222 may execute automated criteria adjustment logic in order to generate the new set of criteria, such as according to configured rules. For example, such configured rules may cause analyzer 222 to apply candidate modifications to the set of criteria, such as to exclude (e.g., when all attributes are in the set of criteria) an attribute indicated in the set of criteria, to replace (e.g., when the set of criteria has a configured size) an attribute indicated in the set of criteria with a different attribute (e.g., an attribute that was not previously indicated in the set of criteria), to modify the distance metric (e.g., changing from L-1 distance to L-2 distance), to modify the weight associated with an attribute, to vectorize the attribute values associated with an attribute, to toggle fuzzy matching in the distance metric for an attribute, and/or the like.

In some examples, such candidate modifications that may be performed as part of the automated criteria adjustment logic are based on a configured prioritized list of matching criteria. Each matching criterion specified in the prioritized list may include an attribute, a distance metric, a weight, and/or the like. Candidate modifications may be automatically determined based on the prioritized list, and may include adding a matching criteria, removing a matching criteria, changing an aspect of a matching criteria (e.g., a distance metric or weight), and/or the like. A mounts of certain modifications (e.g., which distance metric to change to, how much to modify the weight associated with an attribute, and/or the like) may be determined based on configured values (e.g., in particular increments), pseudorandom selection, and/or other techniques that may be appropriate or specified in the configured rules. Automatically generated candidate modifications based on the configured prioritized list of matching criteria may be included in a data structure such as a queue, a stack, and/or the like, such that a candidate modification may be selected on a given iteration by choosing the top item in the data structure (e.g., and then moving that item to the bottom of the data structure) or through some other selection technique.

If analyzer 222 cannot generate a new set of criteria (e.g., when every modification in the configured prioritized list has been used), the matching process may terminate and analyzer 222 may output the maximum matches after excluding the weak matches. However, some items in the first set (e.g., the smaller set) may remain unmatched.

The unmatched items and the new set of criteria can be provided to matcher 220 to generate a new maximum matching for the previously unmatched items. If the new maximum matching is deemed to have satisfactory quality (e.g., with differences based on the new set of criteria not meeting the threshold), analyzer 222 can aggregate the new maximum matching with the previous maximum matching and output the aggregated maximum matching as matching 330.

Otherwise, if some matches are excluded (e.g., based on differences based on the new set of criteria meeting the threshold), analyzer 222 can provide the unmatched items excluded from the new maximum matching and update the new set of criteria (e.g., by replacing attributes or introduce other modifications as discussed above) to provide to matcher 220 for another iteration.

Accordingly, this process continues until an exit condition is met (e.g., when no match is excluded from a maximum matching or when a new set of criteria cannot be generated).

A matching determined using techniques described herein, such as matching 330, may be used to perform a variety of different actions. For example, based on such a matching, content may be displayed via a user interface (e.g., indicating that two items from different electronic data sets are matched to one another, recommending one of the matched items or content related to one or more of the matched items, and/or the like), a classification for one entity may be automatically applied to another entity (e.g., if the two entities share one or more matched items in associated electronic data sets), a merged data set may be automatically generated based on two electronic data sets that includes only one instance of an item that was matched between the two electronic data sets, one of the matched items may be deleted from a corresponding electronic data set to reduce redundancy, an association may be automatically established between two electronic data sets (e.g., the matching may indicate that the two data sets are related), and/or the like. Generally, an action performed based on matching 330 may include displaying content via a user interface based on matching 330, providing matching 330 to one or more components of a software application for further processing, and/or the like.

### Example Process for Matching Items

FIG. 3 depicts an example process 300300 for matching items. Process 300300 can be performed by a predictive model, such as predictive model 200 as shown in FIG. 2 Although process 300300 is depicted to operate on graphs with nodes representing items, process 300 can operate on any appropriate data structures, such as matrices, tables (e.g., Pandas DataFrames), dictionaries, lists, JavaScript Object Notation (JSON) objects, graphs (e.g., nodes in graphs), texts, and/or the like.

Process 300300 starts by receiving two sets of items. Items 1-4 may be a first set of items, such as the first set of items (e.g., a smaller set) as discussed with respect to FIG. 2 Items A-F may be a second set of items, such as the second set of items (e.g., a larger set) as discussed with respect to FIG. 2 Items 1-4 and A-F can indicate multiple attributes, such as “description,” “item_code,” “price,” “title,” “timestamp” and so on.

Maximum matching 310 can be generated between items 1-4 and items A-F based on a set of criteria associated with the attributes. For instance, the set of criteria may indicate “description,” “item_code,” and “price.” Accordingly, a difference between each item 1-4 and each item A-F can be computed based on the set of criteria (e.g., by a matcher, such as matcher 220 as depicted in FIG. 2). A maximum bipartite matching can be performed based on the differences, and the solution to the maximum bipartite matching may be maximum matching 310.

In this example, maximum matching 310 includes 4 matches, between items 1 and D, items 2 and A, items 3 and B, and items 4 and F. Items C and E are unmatched items.

As discussed with respect to FIG. 2 there may be discrepancies or poor data in the attributes included in the set of criteria. Therefore, some matches are weak and may be excluded. The weak matches may have a difference meeting a threshold value, as discussed with respect to FIG. 2 Accordingly, weak matches can be excluded from maximum matching 310.

In this example, matches between items 3 and B and between items 4 and F are weak and are excluded from maximum matching 310 to generate matching 320. For example, the differences between items 3 and B as well as items 4 and F may meet a threshold value, as discussed with respect to FIG. 2

As such, in matching 320, items 3-4 of the first set becomes unmatched, as well as items B, C, E, and F of the second set. Accordingly, items 3-4 of the first set and items B, C, E, and F of the second set are excluded from maximum matching 310.

A maximum bipartite matching can be used to generate a maximum matching between items 3-4 of the first set and items B, C, E, and F of the second set. For example, a new set of criteria can be used to compute the difference between each item 3-4 and each item B, C, E, and F. The new set of criteria may indicate “item_code,” “price,” and “title,” which is different from “description,” “item_code,” and “price” indicated in set of criteria. Additionally, the new set of criteria may include other modifications (e.g., with respect to the distance metric or the weight associated with an attribute) as discussed with respect to FIG. 2 As a result, in aggregated matching 330, item 3 matches with item E and item 4 matches with item B.

Subsequently, the difference computed with respect to the new set of criteria can be used to exclude weak matches in those two matches, which is the match between item 3 and item E. As such, item 3 in the first set and items C, E, and F are unmatched and are excluded from aggregated matching 330, so as to generate matching 340.

In this example, after matching 340 is found, there are no more possible modifications (e.g., in a configured prioritized list). Accordingly, matching 340 may be the output, similar to or the same as matching 330 as depicted in FIG. 2

In some examples, alternatively, the match between item 3 and item E is not excluded from aggregated matching 330, and process 300 terminates and instead outputs aggregated matching 330.

### Example Operations for Enhanced Automated Item Matching

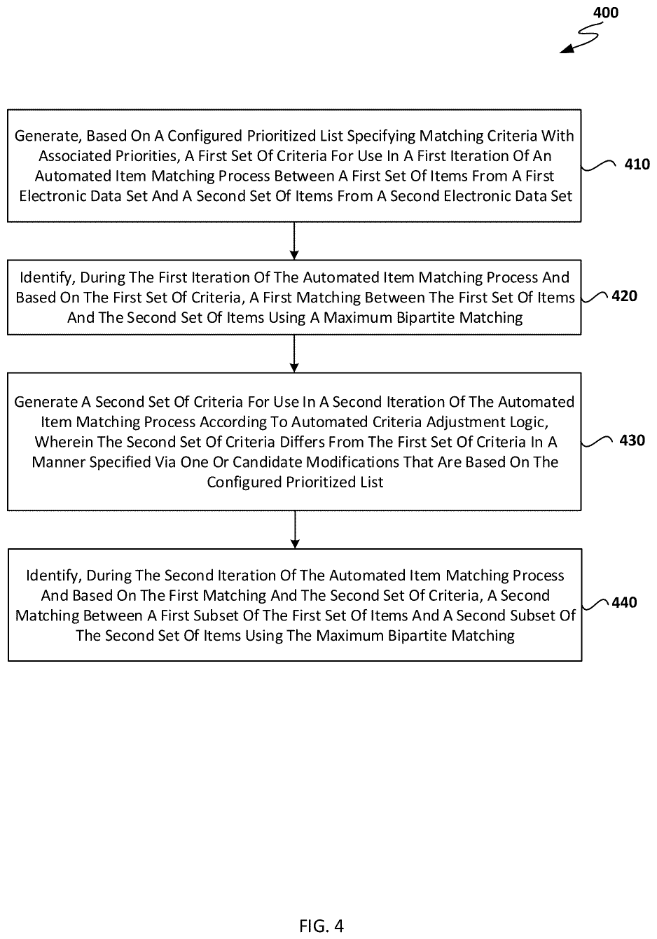

FIG. 4 is a flow diagram of example operations 400 for item matching. Operations 400 may be performed using a predictive model, such as predictive model 200 as illustrated in FIG. 2

Operations 400 begin at step 410, with generating, based on a configured prioritized list specifying matching criteria with associated priorities, a first set of criteria for use in a first iteration of an automated item matching process between a first set of items from a first electronic data set and a second set of items from a second electronic data set. For example, the first set of items can include items 1-4 and the second set of items can include items A-F as depicted in FIG. 3. The first set of criteria can, for instance, be the set of criteria discussed with respect to FIGS. 2-3.

In some embodiments, the generating of the first set of criteria or the generating of the second set of criteria comprises generating, for each criterion in the first set of criteria or the second set of criteria, an indication of an attribute and one or more of: a distance metric associated with the attribute; or a weight associated with the attribute.

In some aspects, the distance metric associated with the attribute comprises one or more of an edit distance, a Manhattan distance, a Euclidean distance, or a cross entropy loss, and wherein the identifying the first matching or the identifying the second matching comprises using the edit distance, the Manhattan distance, the Euclidean distance, or the cross entropy loss for the attribute.

In certain aspects, the distance metric associated with the attribute comprises an indication to use a fuzzy matching technique, and wherein the identifying the first matching or the identifying the second matching comprises using the fuzzy matching technique for the attribute.

Operations 400 continue at step 420, with identifying, during the first iteration of the automated item matching process and based on the first set of criteria, a first matching between the first set of items and the second set of items using a maximum bipartite matching. For example, the first matching can be the maximum matching generated as discussed with respect to FIG. 2 or maximum matching 310 as depicted in FIG. 3.

In some embodiments, the maximum bipartite matching includes one or more of Jonker-Volgenant algorithm, alpha-beta pruning search, Hungarian algorithm, stable marriage algorithm, Blossom algorithm, Hopcroft-Karp algorithm, a cycle canceling algorithm, a successive shortest path algorithm, an out-of-kilter algorithm, network simplex method, push-relabel algorithm, or a linear programing, as discussed with respect to FIG. 2

Operations 400 continue at step 430, with generating a second set of criteria for use in a second iteration of the automated item matching process according to automated criteria adjustment logic, wherein the second set of criteria differs from the first set of criteria in a manner specified via one or candidate modifications that are based on the configured prioritized list. For example, second set of criteria can be new set of criteria as discussed with respect to FIGS. 2-3.

In some aspects, the generating of the first set of criteria or the generating of the second set of criteria comprises generating the weight associated with the attribute using a machine learning model that has been trained based on attributes of item pairs confirmed to be matches.

In certain aspects, the generating the second set of criteria comprises: determining that an attribute is not associated with a criterion in the first set of criteria; and generating, based on the automated criteria adjustment logic, a criterion for inclusion in the second set of criteria based on the attribute. For example, the attribute can replace an attribute in the first set of criteria, as discussed with respect to FIG. 2

In some aspects, the generating the second set of criteria comprises selecting a number of criteria based on a configured size, and wherein the first set of criteria and the second set of criteria have the configured size.

Operations 400 continue at step 440, with identifying, during the second iteration of the automated item matching process and based on the first matching and the second set of criteria, a second matching between a first subset of the first set of items and a second subset of the second set of items using the maximum bipartite matching. For example, the first subset of items can be the subset of the first set of items discussed with respect to FIG. 2 or items 3-4 in matching 320 as depicted in FIG. 3 while the second subset of items can be the subset of the second set of items discussed with respect to FIG. 2 as or items B, C, E, and F in matching 320 as depicted in FIG. 3.

For example, the second matching can be the new maximum matching as discussed with respect to FIG. 2 or the matches between item 3 and item E as well as between item 4 and item B in aggregate matching 330 as depicted in FIG. 3.

In some embodiments, the first set of criteria and the second set of criteria have a same size, such as the configured size for the first set and the second set as discussed with respect to FIG. 2

### Example Application Server

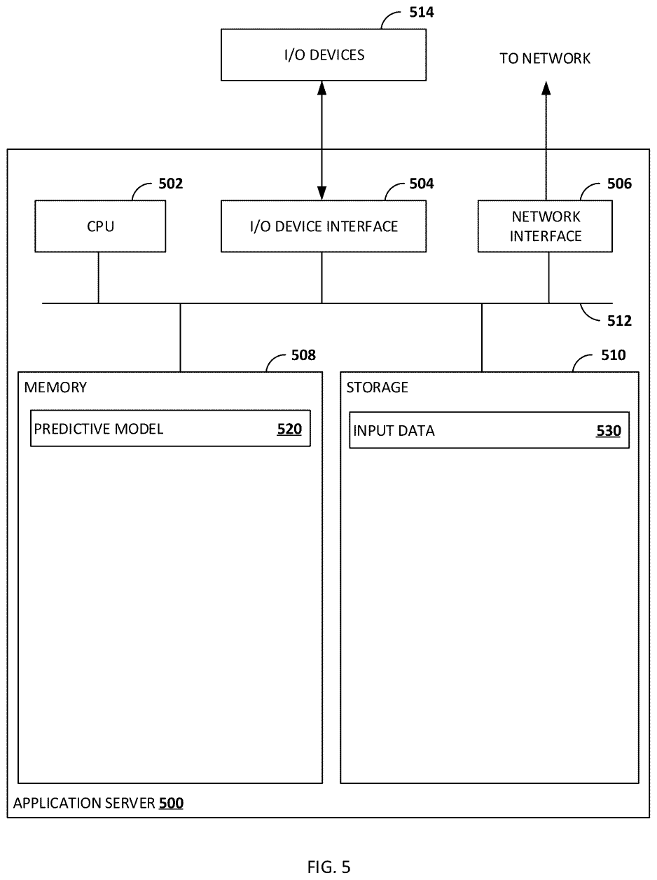

FIG. 5 depicts an example application server 500, which can be used to deploy predictive model 200 of FIG. 2 As shown, application server 500 includes a central processing unit (CPU) 502, one or more input/output (I/O) device interfaces 504, which may allow for the connection of various I/O devices 514514 (e.g., keyboards, displays, mouse devices, pen input, etc.) to application server 500, a network interface 506506, a memory 508508, a storage 510510, and an interconnect 512512.

CPU 502502 may retrieve and execute programming instructions stored in memory 508. Similarly, CPU 502 may retrieve and store application data residing in memory 508. Interconnect 512 transmits programming instructions and application data, among CPU 502, I/O device interface 504, network interface 506, memory 508, and storage 510. CPU 502 is included to be representative of a single CPU, multiple CPUs, a single CPU having multiple processing cores, and the like. I/O device interface 504 may provide an interface for capturing data from one or more input devices integrated into or connected to application server 500, such as keyboards, mice, touchscreens, and so on. Memory 508 may represent a random access memory (RAM) , while storage 510 may be a solid state drive, for example. Although shown as a single unit, storage 510 may be a combination of fixed and/or removable storage devices, such as fixed drives, removable memory cards, network attached storage (NAS), or cloud-based storage.

As shown, memory 508 includes predictive model 520. Predictive model 520 may be the same as or substantially similar to predictive model 200 of FIG. 2 Predictive model 520 may be evaluated or trained using one or more graphics processing units (GPUs), such as a NVIDIA® H100, or similar devices, such as tensor processing units (TPUs).

As shown, storage 510 includes input data 530. Input data 530 may be the same as or substantially similar to input data 110 of FIG. 2

It is noted that the components depicted in application server 500 are included as examples, and other types of computing components may be used to implement techniques described herein. For example, while memory 508 and storage 510 are depicted separately, components depicted within memory 508 and storage 510 may be stored in the same storage device or different storage devices associated with one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

1. A method for enhanced automated item matching across electronic data sets, comprising:
generating, using an embedding machine learning model, embedding vector representations of attributes of a first set of line items from a first electronic data set and embedding vector representations of attributes of a second set of line items from a second electronic data set, wherein a number of line items in the second set of line items is equal to or greater than a number of line items in the first set of line items;
generating a first set of criteria including:
a respective first weight for each line item attribute of the first set of line items and the second set of line items; and
a respective first embedding vector distance for each line item attribute of the first set of line items relative to each line item attribute of the second set of line items based on the embedding vector representations of the attributes of the first set of line items and the embedding vector representations of the attributes of the second set of line items;
identifying a first matching based on using a maximum bipartite matching technique to match each line item of the first set of line items to a respective line item of the second set of line items based on:
the respective first weight for each line item attribute of the first set of line items and the second set of line items; and
the respective first embedding vector distance for each line item attribute of the first set of line items relative to each line item attribute of the second set of line items;
excluding a match between a given line item of the first set of line items and a particular line item of the second set of line items based on:
a given first embedding vector distance between an attribute of the given line item and an attribute of the particular line item exceeding a threshold; and
a given weight for the given line item or the particular line item;
generating a second set of criteria including:
an updated weight for line item attribute of the first set of line items or the second set of line items; and
an updated embedding vector distance between a line item attribute of the first set of line items and a line item attribute of the second set of line items; and
identifying a second matching between the first set of line items and the second set of line items using the maximum bipartite matching technique based on the second set of criteria.

2. The method of claim 1, wherein the the maximum bipartite matching technique comprises performing one or more of a Jonker-Volgenant algorithm, an alpha-beta pruning search, a Hungarian algorithm, a stable marriage algorithm, a Blossom algorithm, a Hopcroft-Karp algorithm, a cycle canceling algorithm, a successive shortest path algorithm, an out-of-kilter algorithm, a network simplex method, a push-relabel algorithm, or a linear programing.

3. (canceled)

4. The method of claim 1, wherein the updated embedding vector distance is based on one or more of an edit distance, a Manhattan distance, a Euclidean distance, or a cross entropy loss.

5. The method of claim 1, wherein the updated embedding vector distance is determined based on updated embedding vector representations of line item attributes.

6. The method of claim 5, wherein the second matching is based on using a fuzzy matching technique.

7. (canceled)

8. (canceled)

9. (canceled)

10. A system for enhanced automated item matching across electronic data sets, comprising:
a memory including computer executable instructions; and
a processor configured to execute the computer executable instructions and cause the system to:
generate, using an embedding machine learning model, embedding vector representations of attributes of a first set of line items from a first electronic data set and embedding vector representations of attributes of a second set of line items from a second electronic data set, wherein a number of line items in the second set of line items is equal to or greater than a number of line items in the first set of line items;
generate a first set of criteria including:
a respective first weight for each line item attribute of the first set of line items and the second set of line items; and
a respective first embedding vector distance for each line item attribute of the first set of line items relative to each line item attribute of the second set of line items based on the embedding vector representations of the attributes of the first set of line items and the embedding vector representations of the attributes of the second set of line items;
identify a first matching based on using a maximum bipartite matching technique to match each line item of the first set of line items to a respective line item of the second set of line items based on:
the respective first weight for each line item attribute of the first set of line items and the second set of line items; and
the respective first embedding vector distance for each line item attribute of the first set of line items relative to each line item attribute of the second set of line items;
exclude a match between a given line item of the first set of line items and a particular line item of the second set of line items based on:
a given first embedding vector distance between an attribute of the given line item and an attribute of the particular line item exceeding a threshold; and
a given weight for the given line item or the particular line item;
generate a second set of criteria including:
an updated weight for a line item attribute of the first set of line items or the second set of line items; and
an updated embedding vector distance between a line item attribute of the first set of line items and line item attribute of the second set of line items; and
identify a second matching between the first set of line items and the second set of line items using the maximum bipartite matching technique based on the second set of criteria.

11. The system of claim 10, wherein the the maximum bipartite matching technique comprises performing one or more of a Jonker-Volgenant algorithm, an alpha-beta pruning search, a Hungarian algorithm, a stable marriage algorithm, a Blossom algorithm, a Hopcroft-Karp algorithm, a cycle canceling algorithm, a successive shortest path algorithm, an out-of-kilter algorithm, a network simplex method, a push-relabel algorithm, or a linear programing.

12. (canceled)

13. The system of claim 10, wherein the updated embedding vector distance is based on one or more of an edit distance, a Manhattan distance, a Euclidean distance, or a cross entropy loss.

14. The system of claim 10, wherein the updated embedding vector distance is determined based on updated embedding vector representations of line item attributes.

15. The system of claim 14, wherein the second matching is based on using a fuzzy matching technique.

16. (canceled)

17. (canceled)

18. (canceled)

19. A method, comprising:
generating vector representations of attributes of a first set of line items from a first electronic data set and vector representations of attributes of a second set of line items from a second electronic data set, wherein a number of line items in the second set of line items is equal to or greater than a number of line items in the first set of line items;
generating a first set of criteria including a respective first distance for each line item attribute of the first set of line items relative to each line item attribute of the second set of line items based on the vector representations of the attributes of the first set of line items and the vector representations of the attributes of the second set of line items;
identifying a first matching based on using a maximum bipartite matching technique to match each line item of the first set of line items to a respective line item of the second set of line items based on the respective first distance for each line item attribute of the first set of line items relative to each line item attribute of the second set of line items;
excluding a match between a given line item of the first set of line items and a particular line item of the second set of line items based on a given first distance between an attribute of the given line item and an attribute of the particular line item exceeding a threshold;
generating a second set of criteria including an updated distance between a line item attribute of the first set of line items and a line item attribute of the second set of line items; and
identifying a second matching between the first set of line items and the second set of line items using the maximum bipartite matching technique based on the second set of criteria.

20. The method of claim 19, wherein the the maximum bipartite matching technique comprises performing one or more of a Jonker-Volgenant algorithm, an alpha-beta pruning search, a Hungarian algorithm, a stable marriage algorithm, a Blossom algorithm, a Hopcroft-Karp algorithm, a cycle canceling algorithm, a successive shortest path algorithm, an out-of-kilter algorithm, a network simplex method, a push-relabel algorithm, or a linear programing.

21. The method of claim 19, wherein the updated distance is based on one or more of an edit distance, a Manhattan distance, a Euclidean distance, or a cross entropy loss.

22. The method of claim 19, wherein the updated distance is determined based on updated vector representations of line item attributes.

23. The method of claim 19, wherein the second matching is based on using a fuzzy matching technique.

24. The method of claim 1, wherein the first weights are generated based on providing the first set of line items and the second set of line items as input to a machine learning model.

25. The system of claim 10, wherein the first weights are generated based on providing the first set of line items and the second set of line items as input to a machine learning model.
